(19) United States
(12) Patent Application Publication
(10) Pub. No.: US 2004/0128005 A1
(43) Pub. Date: Jul. 1, 2004

(54) Apparatus including user interface and method regarding user interface

(75) Inventor: Hiroki Suzukawa, Tochigi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/736,612

(22) Filed: Dec. 17, 2003

(30) Foreign Application Priority Data
Dec. 25, 2002 (JP) 2002-375093

(51) Int. Cl. G05B 15/00

(52) U.S. Cl. 700/83; 700/121

(57) ABSTRACT

An apparatus is disclosed, which includes a user interface unit, a detection unit to detect whether a user exists, and a first setting unit to set an item operable from the user interface unit based on a detection result of the detection unit.

### FIELD OF THE INVENTION

The present invention relates to a user interface technique.

### BACKGROUND OF THE INVENTION

Generally, a semiconductor manufacturing equipment such as an exposure apparatus has a console (apparatus operation unit) for a user to operate the apparatus. In the console, a user level is set so as to limit an operation range in accordance with user.

For example, at a low user level, it is possible to run and stop the apparatus, while at a high user level, it is further possible to change apparatus running conditions. Generally, to perform the high user level operation, the user's password input is required.

However, in some cases, a user who has operated the apparatus at a high user level forgets to set the user level to an initial (low) level upon completion of the operation, or the user temporarily leaves the console for some reason during the operation. In such status, if another operator who is to perform a low user-level operation comes to the console, he/she is enabled to perform an operation which was not permitted. That is, even in a case where authentication processing is provided upon a shift to the high user level, if the user level is not changed to the low user level after the completion of the high level operation, the next user can operate the apparatus at the high user level. As a result, there is a probability that the next user erroneously changes the apparatus running conditions thereby brings the apparatus into a wrong running status.

### SUMMARY OF THE INVENTION

In consideration of the above situation, the present invention has its object to prevent a user from performing an operation beyond his/her user level.

According to one aspect of the present invention, there is provided an apparatus comprising: a user interface unit; a detection unit which detects whether a user exists; and a first setting unit which sets an item operable from the user interface unit based on a detection result of the detection unit.

Further, according to another aspect of the present invention, there is provided a method comprising steps of: detecting whether a user exists with respect to a user interface unit of an apparatus; and setting an item operable from the user interface unit based on a detection result in the detection step.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic front view of a semiconductor exposure apparatus according to an embodiment of the present invention showing the arrangement of a console (apparatus operation unit) and an interpersonal sensor;

FIG. 2 is a flowchart realizing an operation error prevention method according to the embodiment; and

FIG. 3 is a flowchart showing a semiconductor device fabrication process.

### DETAILED DESCRIPTION OF THE PREFERRED EMBODIMENTS

Preferred embodiments of the present invention will now be described in detail in accordance with the accompanying drawings.

[First Embodiment]

Hereinbelow, a first embodiment of the present invention will be described as an operation error prevention method, and an apparatus, to which the method is applied, used in fabrication of devices having a fine pattern, including a micro device such as a semiconductor integrated circuit, a micro machine, a liquid crystal display, a thin-film magnetic head and the like. In the present embodiment, an operation unit of an exposure apparatus will be described. Note that it goes without saying that the application of the present invention is not limited to such particular apparatus.

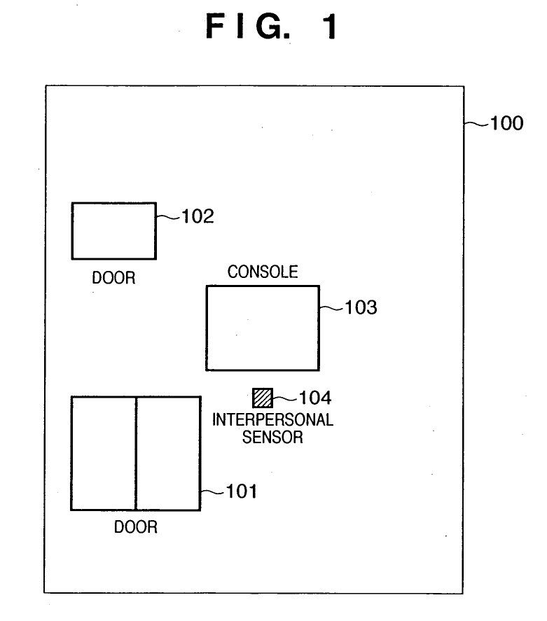

FIG. 1 is a schematic front view of a semiconductor exposure apparatus according to a first embodiment. In FIG. 1, reference numeral 100 denotes an exposure apparatus. Numeral 101 denotes a door for a wafer. A wafer cassette including a wafer is set via the door 101. Numeral 102 denotes a door for a reticle. A reticle is set via the door 102. Note that the reticle means a glass substrate (mask) with a circuit pattern to be transferred onto the wafer.

Numeral 103 denotes a console providing an operation unit (user interface) for a user to perform various operations of the exposure apparatus 100. In the present embodiment, the console 103 includes a touch panel. The user can operate the apparatus by depressing (touching) buttons on the panel. The operations include, e.g., starting of exposure processing, termination of exposure processing, change of exposure conditions, and change of a user level to be described later. Further, the exposure conditions include, e.g., an exposure layout, an exposure amount and focus offset.

When the exposure conditions have been determined by using the console 103, wafer and reticle are set, then an exposure start button is depressed, thereby the exposure processing is started, and the circuit pattern on the reticle is transferred to the wafer. Note that the console operation is not limited to the touch panel operation but may be made by using general button switches, a keyboard, a mouse and the like.

In the present embodiment, two user levels “operator” and “engineer” are prepared in the console. The operation ranges (operation items) of the respective levels are determined as in the following table.

TABLE 1

| Operation | Operator | Engineer |
|---|---|---|
| Start/stop exposure | ◯ | ◯ |
| processing | | |
| Change exposure | X | ◯ |
| conditions | | |
| Change user level | ◯ | ◯ |

◯: permitted
X: not permitted

In this case, the engineer user level is higher than the operator user level. It is assumed, as general apparatus running form, that an engineer sets exposure conditions and an operator executes exposure processing. That is, it is assumed that the engineer knows appropriate settings of exposure conditions, while the operator does not know the settings. If wrong exposure conditions are set, a defective wafer is obtained. Accordingly, it is arranged such that the operator who does not know appropriate settings of exposure conditions cannot change the exposure conditions. When the user level is “operator”, the user can “start/stop exposure processing” and “change user level”. When the user level is “engineer”, the user can “change exposure conditions” as well as the user can “start/stop exposure processing” and “change user level”.

Note that to change the “operator” user level to the “engineer” level, a password must be inputted upon user level change operation.

Further, an infrared interpersonal sensor 104 is provided below the touch panel of the console 103. When someone exists within a distance of about 50 cm from the sensor 104, the sensor is turned ON, and when the person is away from the sensor by at least about 50 cm, the sensor is turned OFF. The sensor ON/OFF distance can be changed in accordance with sensitivity control of the sensor.

Next, control to realize an operation error prevention method regarding the console 103 according to the present embodiment having the above construction will be described below.

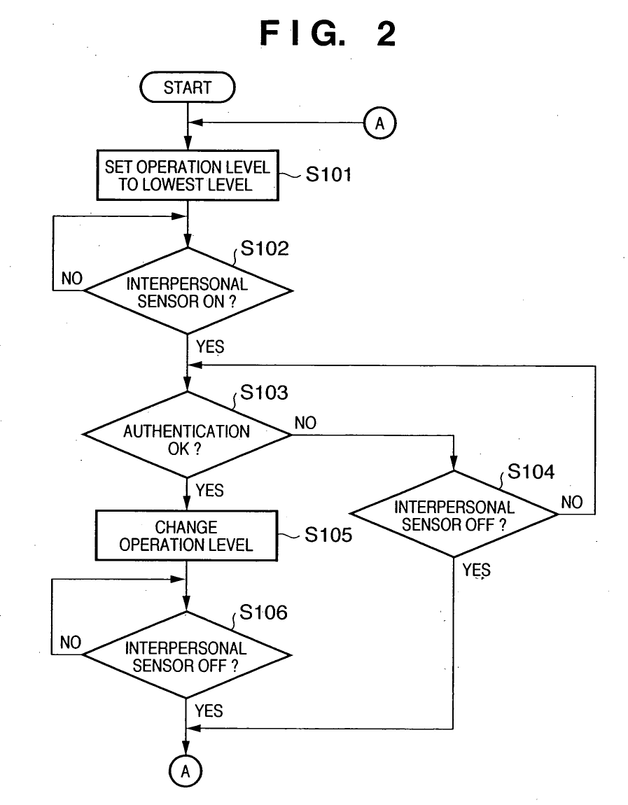

FIG. 2 is a flowchart showing the operation error prevention method according to the present embodiment. It is detected that a user has left the consol by detecting that the state of the interpersonal sensor 104 has been changed from ON to OFF. At this time, if the user level is “engineer” (high user level), the user level is changed to “operator” (low user level).

Note that the processing is realized by executing a control program stored in a memory (not shown) of a CPU (not shown) of the exposure apparatus. Note that in a case where the console 103 has a CPU, the following processing may be executed by the CPU of the console 103.

First, at step S101, the operation level is set to an initial state. In the present embodiment, the operation level is set to a lowest level (user level: operator). Then at step S102, the process waits until the interpersonal sensor 104 is turned ON. When the interpersonal sensor 104 has been turned ON, the process proceeds to step S103. At step S103, authentication processing is performed. If the result of authentication is OK, the process proceeds to step S105. If the authentication is not performed or if the result of authentication is not successful, the process proceeds to step S104. At step S104, it is determined whether or not the interpersonal sensor 104 has been turned OFF. If it is determined that the sensor has been turned OFF, the process returns to step S101. Note that in this case, as the operation level is still low, the process may return to step S102. If it is determined at step S104 that the interpersonal sensor 104 is ON, the processing at step S103 is repeated.

In the loop of the above-described steps S103 and S104, the user can operate the console 103 at the low user level. That is, the user can perform operations at the low user level before the user passes the authentication processing.

On the other hand, if the result of authentication at step S103 is successful, the process proceeds to step S105, at which the operation level is changed. In the present embodiment, the user level is changed to “engineer”, and the exposure conditions can be changeable. Thereafter, the process waits until the interpersonal sensor 104 is turned OFF. When the interpersonal sensor 104 has been turned OFF, the process returns to step S101, at which the user level is set to the lowest user level (operator).

As described above, according to the present embodiment, it is recognized, based on a signal from the sensor (interpersonal sensor 104) to detect the existence of person in a position around the user-operable operation unit (console 103), whether or not the person has left the position around the operation unit (S106). If it is recognized that the person has been away from the position around the operation panel, the operation range at the operation unit (user level) is changed (S101). That is, the operation level is automatically set in accordance with the detection of existence/absence of user around the operation unit. In other words, an operation item manipulable from the operation unit 103 is changed in accordance with the detection of existence/absence of user around the operation unit. Accordingly, an operation error at the operation unit can be prevented by, e.g., setting the operation level to the low level when absence of user is detected.

Note that it is preferable that the user level is changed to a level of narrowest operation range. The level of narrowest operation range means, e.g., a user level automatically set upon start-up (power-on) of the apparatus. Otherwise, as described in the second embodiment, the operation range may be changed to a level at which the apparatus (exposure apparatus 100) cannot be operated at all.

Further, it is preferable that the operation range at the operation unit is changed in correspondence with a predetermined operation at the operation unit (S103 and S105). As the predetermined operation, an authentication operation can be performed. In this case, it is arranged such that if the identity of the user is confirmed in the authentication operation, the operation range at the operation unit is enlarged. The authentication operation may be performed by various processing such as password input and authentication using fingerprint or the like.

Further, in the above construction, it may be arranged such that different operation ranges are set for users identified in the authentication operation. For example, user levels A, B and C are prepared, then the user level A is set at step S101, and user level B or C is set at step S105 in accordance with the identified user. In this case, it is necessary to register the levels of the respective users in advance.

[Second Embodiment]

In the second embodiment, upon start of console operation, a log-in operation is first performed (any operation cannot be made without log-in operation). The user level is determined by the log-in operation. In addition, if it is detected that the user has left the console, the console operation is logged-out. In this case, it may be arranged such that the lowest level is set to a level at which any operation of the exposure apparatus 100 is disabled at step S101 in FIG. 2 but only the authentication can be performed. Further, at step S105, the operation level may be changed to a user level registered in accordance with the identified user as described above.

This method has inconvenience that once the user leaves the console, the log-in operation must be made for the next operation. However, an operation error can be more reliably prevented.

Note that various modifications can be made as well as the above embodiments. For example, it may be arranged such that at step S101, any operation is disabled but an operation at the lowest level is permitted based on an ON state of the interpersonal sensor 104 as a trigger, further, it may be arranged such that a higher user level operation is enabled through the authentication.

As described above, according to the above embodiments, the present invention prevents an accident that an operator at a low user level inadvertently perform an operation which was not permitted and changes the running status of an apparatus. In the case of a semiconductor manufacturing apparatus, the invention prevents an accident that a defective wafer is manufactured as a result of erroneous change of exposure conditions.

Further, according to the above embodiment, it is possible to detect that a user has left an operation unit and automatically set an operation level, thereby prevent an operation error at the operation unit.

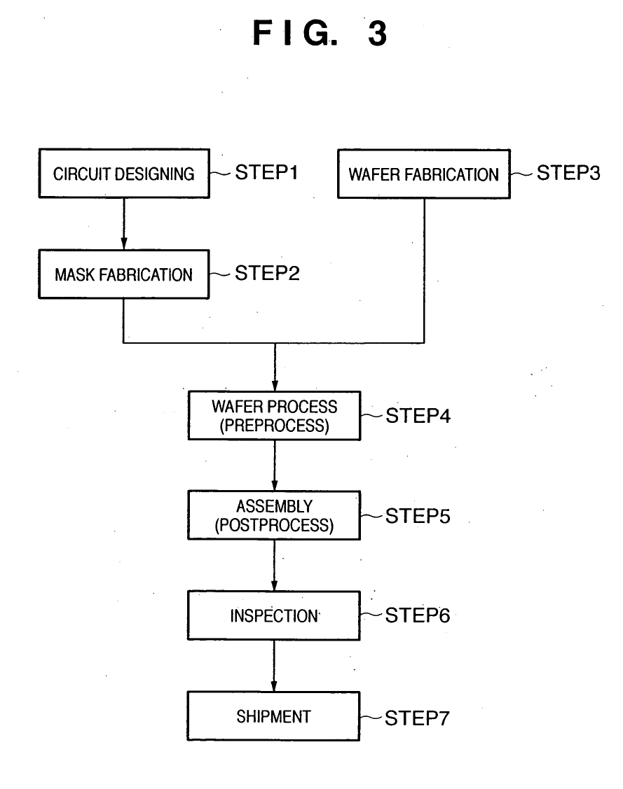

Next, a semiconductor device fabrication process will be described as an example of micro device fabrication utilizing the above-described exposure apparatus. FIG. 3 is a flowchart showing the entire semiconductor device fabrication process. At step 1 (circuit designing), a device circuit is designed. At step 2 (mask fabrication), a mask is fabricated based on the designed circuit pattern.

On the other hand, at step 3 (wafer fabrication), a wafer (substrate) is fabricated by using material such as silicon. At step 4 (wafer process), called a preprocess, an actual circuit is formed on the wafer by a lithography technique using the above mask and wafer by the above-described exposure apparatus. At the next step 5 (assembly), called a postprocess, a semiconductor chip is fabricated by using the wafer carrying the circuit formed at step 4. Step 5 includes an assembly process (dicing and bonding), a packaging process (chip encapsulation) and the like. At step 6 (inspection), inspections such as an operation check, a durability test and the like are performed on the semiconductor device formed at step 5. The semiconductor device is completed through these processes, and is shipped (step 7).

The wafer process at step 4 includes: an oxidation step of oxidizing the surface of the wafer; a CVD step of forming an insulating film on the surface of the wafer; an electrode formation step of forming electrodes on the wafer by vapor deposition; an ion implantation step of injecting ions in the wafer; a resist processing step of coating the wafer with photoresist; an exposure step of transferring the circuit pattern onto the wafer subjected to the resist processing step by the above-described exposure apparatus; a development step of developing the wafer exposed at the exposure step; an etching step of removing other portions than the developed resist; and a resist stripping step of removing the resist which is unnecessary after the completion of etching. These steps are repeated, to form a multiple layers of circuit patterns on the wafer.

As many apparently widely different embodiments of the present invention can be made without departing from the spirit and scope thereof, it is to be understood that the invention is not limited to the specific embodiments thereof except as defined in the appended claims.

What is claimed is:

1. An apparatus comprising:
a user interface unit;
a detection unit which detects whether a user exists; and
a first setting unit which sets an item operable from said user interface unit based on a detection result of said detection unit.

2. An apparatus according to claim 1, wherein said first setting unit sets the item based on a change from existence of a user to absence of the user.

3. An apparatus according to claim 1, wherein said first setting unit minimizes number of the items based on a change from existence of a user to absence of the user.

4. An apparatus according to claim 1, further comprising a second setting unit which sets the item based on a predetermined operation from said user interface unit.

5. An apparatus according to claim 4, wherein said predetermined operation includes an input operation for user authentication.

6. An apparatus according to claim 5, wherein said second setting unit sets the item based on a user authenticated due to said input operation.

7. An apparatus according to claim 1, wherein said first setting unit sets, as the item, an input operation for user authentication, based on a change from existence of a user to absence of the user.

8. An apparatus according to claim 1, wherein the apparatus includes a device manufacturing apparatus.

9. An apparatus according to claim 1, wherein the apparatus includes an exposure apparatus for exposing a substrate to a pattern.

10. A device manufacturing method, comprising a step of exposing a substrate to a pattern using an apparatus defined in claim 9.

11. A method comprising steps of:
detecting whether a user exists with respect to a user interface unit of an apparatus; and
setting an item operable from the user interface unit based on a detection result in said detecting step.
